(19) United States
(12) Patent Application Publication
(10) Pub. No.: US 2008/0259973 A1
(43) Pub. Date: Oct. 23, 2008

(54) Wavelength converted laser apparatus

(75) Inventors: Hong Ki Kim, Yongin (KR); Bae Kyun Kim, Sungnam (KR); June Sik Park, Yongin (KR); Dong Hoon Kang, Yongin (KR); Sang Su Hong, Suwon (KR); Chang Yun Lee, Suwon (KR); Tak Gyum Kim, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/081,398

(22) Filed: Apr. 15, 2008

(30) Foreign Application Priority Data
Apr. 17, 2007 (KR) 10-2007-0037383

(51) Int. Cl. H01S 3/10

(52) U.S. Cl. 372/20

(57) ABSTRACT

a wavelength converted laser apparatus includes a laser oscillator emitting an excitation laser beam having a first wavelength, a harmonic wave generator converting the excitation laser beam into a beam having a second wavelength lower than the first wavelength and an optical parametric oscillator converting and outputting the beam having the second wavelength into a beam having a continuously selectable specific wavelength. The optical parametric oscillator has an OPO crystal, a SHG crystal disposed at an output terminal of the optical parametric oscillator crystal to generate a second harmonic beam and a pair of high reflectivity mirrors for amplifying the beam outputted from the optical parametric oscillator.

### CROSS-REFERENCE TO RELATED APPLICATIONS

This application claims the priority of Korean Patent Application No. 2007-37383 filed on Apr. 17, 2007, in the Korean Intellectual Property Office, the disclosure of which is incorporated herein by reference.

### BACKGROUND OF THE INVENTION

1. Field of the Invention

The present invention relates to a wavelength converted laser apparatus, and more particularly, to a high-output wavelength converted laser apparatus capable of emitting a wavelength light in a broader band including a short wavelength and having higher conversion efficiency.

2. Description of the Related Art

A wavelength converted laser, which has been an object of pure research, is likely to be broadened in its use to medical equipment, measurement equipment and various displays and optical record apparatuses. However, in general, the wavelength converted laser hardly attains various wavelengths including a visible light band and achieves low output due to low conversion efficiency.

Until now, a variety of lasers such as a gas laser (CO₂, HeNe, and etc.), a solid laser (Ti:Sapphire, Nd:YAG, and etc.), a semiconductor laser (AlGaAs, GaN, and etc.), and a fiber laser (Er:Fiber and etc.) have been developed and applied, but problems associated with the wavelength conversion laser have not been overcome.

Conventionally, as a wavelength converted solid laser, several lasers employing transition metal (e.g., Mn, Co, Ti, and etc.) ions as an active material have been developed but entailed a drawback of a limited converted wavelength range.

Moreover, a wavelength conversion technology utilizing second harmonic wave generation of a non-linear medium has been developed. However, this only generates a ½ wavelength of a fundamental wave, thus hardly assuring a laser capable of converting a wavelength continuously.

### SUMMARY OF THE INVENTION

An aspect of the present invention provides a high-output wavelength converted laser apparatus ensuring a wavelength of a broader band and having relatively higher conversion efficiency.

According to an aspect of the present invention, there is provided a wavelength converted laser apparatus including: a laser oscillator emitting an excitation laser beam having a first wavelength; a harmonic wave generator converting the excitation laser beam into a beam having a second wavelength lower than the first wavelength; and an optical parametric oscillator converting and outputting the beam having the second wavelength into a beam having a continuously selectable specific wavelength, wherein the optical parametric oscillator includes: an optical parametric oscillator (OPO) crystal generating a signal wave beam having the specific wavelength and an idler wave beam from the second wavelength; a second harmonic generating (SHG) crystal disposed at an output terminal of the OPO crystal to generate a second harmonic beam from the signal wave beam; and a pair of high reflectivity mirrors disposed at an input terminal of the OPO crystal and an output terminal of the SHG crystal, respectively to amplify the beam outputted from the optical parametric oscillator.

The harmonic wave generator may include: a second harmonic generator (SHG) crystal for excitation laser beam generating a second harmonic beam from the excitation laser beam; and a third harmonic generating (THG) crystal generating a third harmonic beam from the second harmonic beam generated from the excitation laser beam, wherein the beam having the second wavelength is the third harmonic beam.

The excitation laser beam may have the first wavelength of 1000 to 1100 nm, the wavelength selectable by the OPO crystal may range from 400 to 2000 nm and the beam outputted from the optical parametric oscillator may have a wavelength ranging from 200 to 2000 nm.

The optical parametric oscillator may select the beam of the specific wavelength by changing an incident angle of the beam having the second wavelength with respect to the OPO crystal. The optical parametric oscillator may further include an OPO crystal rotator rotating the OPO crystal so as to change the incident angle of the beam having the second wavelength with respect to the OPO crystal.

The wavelength converted laser apparatus may further include a light exit position adjustor compensating for a shift in exit position of the outputted beam using the SHG crystal of the optical parametric oscillator so that the beam is outputted to a desired exit position.

The light exit position adjustor may include: an SHG crystal rotator rotating the SHG crystal so as to change the incident angle of the beam having the second wavelength with respect to the SHG crystal of the optical parametric oscillator; and a rotational driving controller controlling a rotational amount of the SHG crystal of the optical parametric oscillator so as to compensate for the shift in the exit position of the outputted beam according to rotation of the OPO crystal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a wavelength converted laser apparatus according to an exemplary embodiment of the invention; and

FIG. 2 is a schematic view illustrating an optical parametric oscillator functioning to adjust light exit position, applicable to a wavelength converted laser apparatus according to an exemplary embodiment of the invention.

### DETAILED DESCRIPTION OF THE PREFERRED EMBODIMENT

Exemplary embodiments of the present invention will now be described in detail with reference to the accompanying drawings.

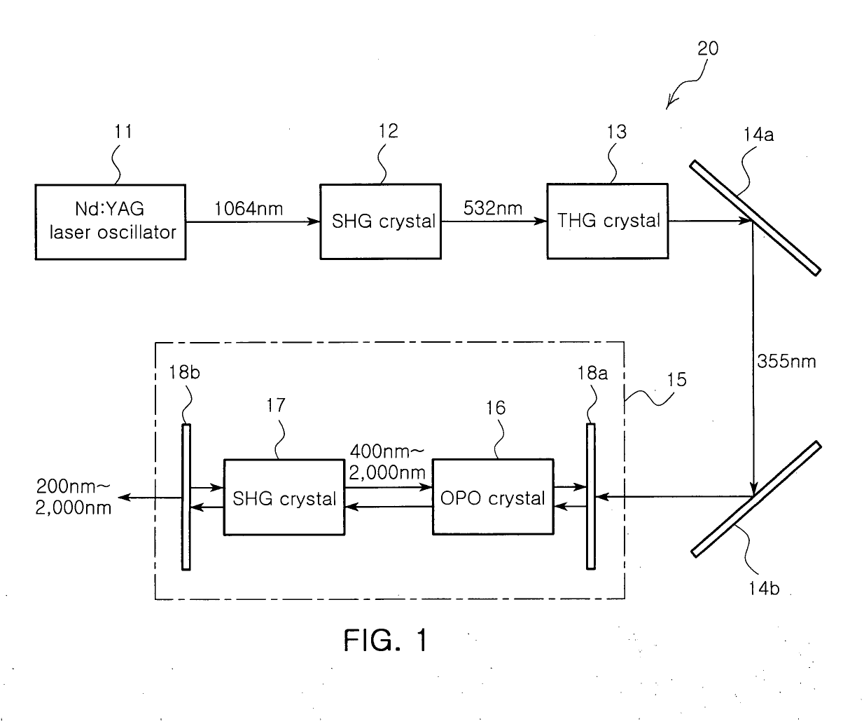

FIG. 1 is a schematic view illustrating a wavelength converted laser apparatus 20 according to an exemplary embodiment of the invention.

As shown in FIG. 1, the wavelength converted laser apparatus 20 of the present embodiment includes a laser oscillator 11 providing an excitation laser beam, a harmonic wave generator having a first second harmonic generator (SHG) crystal 12 and a third harmonic generator (THG) crystal 13, and an optical parametric oscillator 15. Also, the wavelength converted laser apparatus 20 may further include an appropriate optical system, e.g., first and second mirrors 14a and 14b, required for changing an optical path.

The laser oscillator 11 may be adequately selected according to a wavelength range of a desired final output beam. The laser oscillator 11 may be configured to provide an excitation beam having a wavelength of 1000 to 1100 nm to obtain a wavelength light including an ultraviolet ray band and a visible light band. As a representative example, the laser oscillator 11 may be an Nd:YAG laser oscillator providing a beam with a wavelength of about 1064 nm as in the present embodiment.

The harmonic wave generator converts the excitation laser beam into a harmonic beam with a lower wavelength. As in the present embodiment, the harmonic wave generator may include the first SHG crystal 12 and the THG crystal 13. Meanwhile, the laser oscillator 11 may employ the Nd:YAG laser oscillator as in the present embodiment, an then the excitation beam having a wavelength of about 1064 nm is converted into a beam having a wavelength of about 532 nm, i.e., ½ wavelength via the first SHG crystal 12, and then again into a beam having about 355 nm via the THG crystal 13.

The beam having a wavelength of 355 nm obtained from the THG crystal 13 of the harmonic wave generator through the first and second mirrors 14a and 14b can be provided to the optical parametric part 15.

The optical parametric oscillator 15 includes an optical parametric oscillator (OPO) crystal 16 capable of selectively converting the laser beam into a beam having a predetermined wavelength range, a second SHG crystal 17 and a pair of high reflectivity mirrors 18a and 18b amplifying the beam outputted. The first and second high reflectivity mirrors 18a and 18b define a cavity structure for amplifying a final output beam.

The OPO crystal 16 generates a signal wave beam having a different wavelength and an idler beam from the second wavelength. The OPO crystal may employ a known non-linear crystal such as a BaB₂O₄ crystal.

A frequency of the beam incident on the OPO crystal 16 is defined as a sum (ωₛ+ωᵢ) of respective frequencies of the continuously selectable signal wave beam and an idler wave beam. Here, the signal wave has a frequency (ωₛ) greater than a frequency (ωᵢ) of the idler wave. That is, the OPO crystal allows generation of the signal wave beam in a visible light band and generation of the idler beam in an ultraviolet ray having a longer wavelength than the signal wave.

As in the present embodiment, when a beam having a wavelength of about 355 nm is incident on the OPO crystal, a selectable wavelength ranges from about 400 to 1100 nm. Wavelength conversion for selecting a beam of a desired wavelength in this range can be carried out by a known means such as change in an incident angle with respect to the OPO crystal and temperature change. The wavelength conversion by temperature change disadvantageously requires time for stabilizing temperature. Thus wavelength conversion may be performed by changing an incident angle.

As described above, a desired wavelength light can be selected in a predetermined band using the OPO crystal 16. However, the wavelength range selectable only with the OPO crystal 16 is limited, and a necessary wavelength range may be excluded. As in the present embodiment, when the beam has a wavelength of about 400 to 2000 nm, a partial band of the visible light ray, which is a short wavelength and the ultraviolet ray band can not be obtained. This drawback can be overcome by employing the second SHG crystal 17.

In the present embodiment, the second SHG crystal 17 is capable of obtaining an ultraviolet ray beam having a wavelength of about 200 nm by generating the second harmonic beam from a portion of the signal wave beam. Other OPO beam components may not be changed while passing through the second SHG crystal 17. Consequently, a beam having a wavelength of 200 to 2000 nm can be selectively provided. Noticeably, recently, in view of increase in a demand for a laser in an ultraviolet ray light range, e.g., for medical and industrial purpose, the wavelength conversion laser converting an ultraviolet ray is considerably beneficial.

The second SHG crystal 17 arranged according to the present embodiment offers additional advantages in terms of conversion efficiency. In a case where the SHG crystal is disposed at an output end of the OPO crystal without employing the cavity, when the wavelength conversion occurs in the aforesaid conversion range, out of beams obtained from the OPO crystal 16, the short wavelength beam obtained from the second harmonic beam via the second SHG crystal 17 may be very low in conversion efficiency.

More specifically, according to the present embodiment, conversion efficiency in each process is assumed to be 40% for the first SHG crystal, 15% for the THG crystal, 5% for the OPO crystal and 1.5% for the second SHG crystal, when the Nd:YAG beam is assumed to have an intensity of 100%. That is, an excitation laser beam having an intensity of 100 exhibits a low final conversion efficiency of 1.5% when passing through a plurality of non-linear crystals for wavelength conversion.

This low final conversion efficiency can be noticeably improved by disposing the second SHG crystal 17 inside the OPO cavity. That is, in the present embodiment, the second SHG crystal is placed between the first and second high reflectivity mirrors 18a and 18b defining the OPO cavity.

In this arrangement, the beam converted by the OPO crystal 16 and the second SHG crystal 17 inside the OPO cavity can be amplified, thus having conversion efficiency similar to conversion efficiency of the OPO crystal 16. For example, when the Nd:YAG beam has an intensity of 100, the conversion efficiency is 40% for the first SHG crystal, 15% for the THG crystal, 4% for the OPO crystal and the second SHG crystal. That is, the final output beam is improved in conversion efficiency by at least 2.5 times over a configuration in which the second SHG crystal 17 is disposed outside the OPO cavity.

In the present embodiment, the harmonic wave generator is illustrated to include the SHG crystal 12 for excitation laser beam generating a second harmonic beam from the excitation laser beam and the THG crystal 13 generating a third harmonic beam from the second harmonic beam generated from the excitation laser beam. However, this configuration of the harmonic wave generator may be varied according to a desired wavelength of the final output beam and/or a wavelength of the excitation laser beam.

The wavelength converted laser apparatus of the present embodiment converts the beam outputted from the OPO crystal through the additional SHG crystal, thereby expanding a selective wavelength range of the beam into even a short wavelength. Also, the additional SHG crystal is disposed inside the OPO cavity to remarkably improve final conversion efficiency.

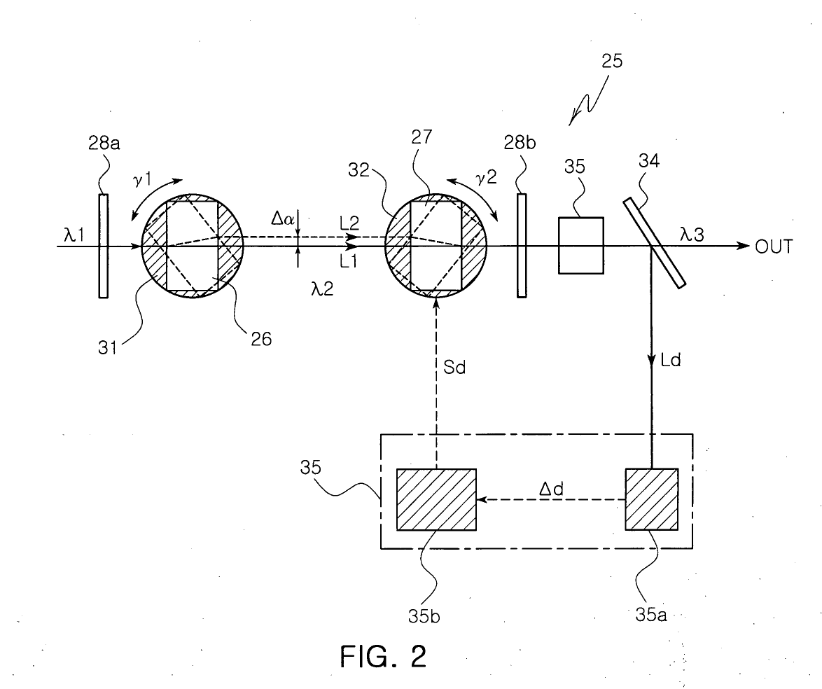

Moreover, the additional SHG crystal can offer another advantage according to a wavelength selection method of the OPO crystal. More specifically, in a case where the wavelength of the OPO crystal is selected by adjusting an incident angle of the beam, the SHG crystal disposed at the output terminal of the OPO crystal may be utilized to ease a problem associated with a shift in exit position of the beam. This embodiment will be explained with reference to FIG. 2.

FIG. 2 is a schematic view illustrating an optical parametric oscillator functioning to adjust light exit position, applicable to a wavelength converted laser according to an exemplary embodiment of the invention.

In a similar manner to FIG. 1, the optical parametric oscillator 25 shown in FIG. 2 includes an optical parametric oscillator (OPO) crystal 26 converting an incident beam λ₁ into an optical parametric oscillator (OPO) beam λ₂ having a different wavelength, a SHG crystal 27 generating a second harmonic beam λ₃ from the OPO beam λ₂, and first and second high reflectivity mirrors 28a and 28b disposed at an input terminal of the OPO crystal 26 and an output terminal of the SHG crystal 27, respectively to amplify an output beam.

In the present embodiment, as described above, the OPO crystal 26 is disposed on a rotator 31 to be rotated along an axis orthogonal to an optical path. An incident angle of the wavelength beam with respect to the OPO crystal 26 is changed using the rotator 31 to select the OPO beam λ₂ of a desired wavelength.

When this OPO crystal 26 is rotated, the incident beam λ₁ on the OPO crystal 25 is changed to thereby shift an exit position L2 of the OPO wavelength beam from an original exit position L1.

In the present embodiment, a light exit position adjustor is employed to compensate for a shift Δα in this exit position by rotational adjustment of the SHG crystal 27. The light exit position adjustor monitors a shift in exit position of the second harmonic beam λ₃ to compensate for the shift Δα in the exit position. This shift in the exit position can be compensated for via the SHG crystal rotator 32.

The SHG crystal rotator 32 rotates the SHG crystal 35 to change an incident angle of the OPO beam λ₂ to thereby adjust the second harmonic beam λ₃ to a desired range. The SHG rotator 32 may be a rotational device similar to the OPO rotator 31. However, the SHG rotator 32 is driven to compensate for the shift in exit position resulting from rotation of the OPO rotator 31. Thus, the SHG rotator 32 has a rotating axis parallel to a rotating axis of the OPO rotator 31 but is rotated in an opposite direction.

The light exit position adjustor of the present embodiment includes a rotational driving controller controlling a rotational amount of the SHG controller 32 to compensate for the shift in exit position caused by rotation of the OPO rotator 31. The SHG rotation driving controller includes a beam distributor 34 detecting a portion Ld of a beam outputted from the SHG crystal 27 and an electronic controller 35 driving the SHG rotator 32 in response to a rotational control signal Sd determined by the detected beam portion Ld. As in the present embodiment, the beam distributor 34 may be disposed at an arbitrary location where the beam can be changed in exit position.

In the present embodiment, the rotational driving controller for an optical member provides information on the shift in exit position using a spatial filter 33. The spatial filter 33 may be structured as a slit formed along a direction where the beam is outputted. The output amount of the beam passing through the slit is changed according to the shift in the exit position of the second harmonic beam λ₃, thereby providing information on the exit position.

In the present embodiment, the spatial filter 33 is disposed between the SHG crystal 27 and the beam distributor 34. However, in a case where the beam portion Ld detected from the beam distributor 34 has information pertaining to exit position, the spatial filter 33 may be disposed between the beam distributor 34 and the electronic controller 35. Moreover, the electronic controller 35 may include an output monitor 35a detecting a shift level Δd of the exit position according to rotation γ₁ of the OPO crystal 26, and a driving controller 35b generating a control signal Sd for changing an incident angle of the SHG crystal 27 according to the detected shift level Δd of the exit position to transmit to the SHG rotator 32.

As described above, in the wavelength converted laser apparatus employing the optical parametric oscillator shown in FIG. 2, the output beam can maintain its exit position by the light exit position adjustor despite a process where the wavelength is selected by rotation of the OPO crystal.

The embodiment shown in FIG. 2 does not limit the present invention, and the optical parametric oscillator of FIG. 2 may further include or be substituted by an optical system for rotating the SHG crystal to compensate for the shift in the exit position.

As described above, when the OPO crystal for obtaining a desired wavelength is changed in a rotational angle, the output beam is changed in position and thus hardly applicable to an area requiring a precise position of the exit beam. However, as shown in FIG. 2, the output beam can maintain its position precisely by appropriately adjusting an angle of the SHG crystal. Even though the SHG crystal may be changed to a position having a specific incident angle for desired wavelength conversion, the OPO crystal and the SHG crystal can be differently adjusted in refractivity and a rotational angle for converting the wavelength. Also, the SHG crystal can be optimized in length to thereby maintain the position of the output beam in an appropriate range.

As set forth above, according to exemplary embodiments of the invention, the OPO crystal and the SHG crystal are combined together to convert a beam into a broader wavelength range. Also, the OPO crystal and the SHG crystal are disposed together inside an OPO cavity structure, thereby enhancing conversion efficiency of a final output beam. Moreover, an SHG crystal disposed inside the OPO cavity is utilized to appropriately compensate for a shift in the exit position resulting from positional adjustment of the OPO crystal.

While the present invention has been shown and described in connection with the exemplary embodiments, it will be apparent to those skilled in the art that modifications and variations can be made without departing from the spirit and scope of the invention as defined by the appended claims.

What is claimed is:

1. A wavelength converted laser apparatus comprising:
a laser oscillator emitting an excitation laser beam having a first wavelength;
a harmonic wave generator converting the excitation laser beam into a beam having a second wavelength lower than the first wavelength; and
an optical parametric oscillator converting and outputting the beam having the second wavelength into a beam having a continuously selectable specific wavelength,
wherein the optical parametric oscillator comprises:
an optical parametric oscillator crystal generating a signal wave beam having the specific wavelength and an idler wave beam from the second wavelength;
a second harmonic generator crystal disposed at an output terminal of the optical parametric oscillator crystal to generate a second harmonic beam from the signal wave beam; and
a pair of high reflectivity mirrors disposed at an input terminal of the optical parametric oscillator crystal and an output terminal of the second harmonic generator crystal, respectively to amplify the beam outputted from the optical parametric oscillator.

2. The wavelength converted laser apparatus of claim 1, wherein the harmonic wave generator comprises:
a second harmonic generator crystal for excitation laser beam generating a second harmonic beam from the excitation laser beam; and
a third harmonic generator crystal generating a third harmonic beam from the second harmonic beam generated from the excitation laser beam,
wherein the beam having the second wavelength is the third harmonic beam.

3. The wavelength converted laser apparatus of claim 2, wherein the excitation laser beam has the first wavelength of 1000 to 1100 nm, the wavelength selectable by the optical parametric oscillator crystal ranges from 400 to 2000 nm and the beam outputted from the optical parametric oscillator has a wavelength ranging from 200 to 2000 nm.

4. The wavelength converted laser apparatus of claim 1, wherein the optical parametric oscillator selects the beam of the specific wavelength by changing an incident angle of the beam having the second wavelength with respect to the optical parametric oscillator crystal.

5. The wavelength converted laser apparatus of claim 4, wherein the optical parametric oscillator further comprises an optical parametric oscillator crystal rotator rotating the optical parametric oscillator crystal so as to change the incident angle of the beam having the second wavelength with respect to the optical parametric oscillator crystal.

6. The wavelength converted laser apparatus of claim 5, further comprises a light exit position adjustor compensating for a shift in exit position of the outputted beam using the second harmonic generator crystal of the optical parametric oscillator so that the beam is outputted to a desired exit position.

7. The wavelength converted laser apparatus of claim 6, wherein the light exit position adjustor comprises:
an second harmonic generator crystal rotator rotating the second harmonic generator crystal so as to change the incident angle of the beam having the second wavelength with respect to the second harmonic generator crystal of the optical parametric oscillator; and
a rotational driving controller controlling a rotational amount of the second harmonic generator crystal of the optical parametric oscillator so as to compensate for the shift in the exit position of the outputted beam according to rotation of the optical parametric oscillator crystal.
